(19) United States
(12) Patent Application Publication
(10) Pub. No.: US 2006/0123988 A1
(43) Pub. Date: Jun. 15, 2006

(54) Method for producing a useful compound and treating a wastewater using pure oxygen

(76) Inventors: Ho Nam Chang, Seoul (KR); Seung Teak Chang, Daejeon (KR); Chul Hee Ryu, Daejeon (KR); Longan Shang, Daejeon (KR)

Correspondence Address: INTELLECTUAL PROPERTY / TECHNOLOGY LAW, PO BOX 14329, RESEARCH TRIANGLE PARK, NC, 27709, US

(21) Appl. No.: 10/538,608

(22) PCT Filed: Feb. 3, 2004
(86) PCT No.: PCT/KR04/00189

§ 371 Date: Jan. 12, 2006

(30) Foreign Application Priority Data
Feb. 4, 2003 (KR) 10-2003-0007045

(51) Int. Cl. B01D 53/02

(52) U.S. Cl. 95/96

(57) ABSTRACT

A method of using pure oxygen in microbial fermentation processes and wastewater treatment processes, in which the pure oxygen is produced by a pressure swing adsorption (PSA) process from a gas mixture of air and unused oxygen-containing recycled off-gas from microbial processes which uses oxygen-containing gas in a liquid or gas state. When pure oxygen with a purity of more than 90% is used in microbial processes, microbial productivity can be about 5 times as increased as it is that in the conventional method using air with an oxygen content of 21%, and the volume of an active sludge tank in wastewater treatment processes can be reduced to at most ⅕ of the volume as compared to the conventional method. Also, the off-gas from such pure oxygen processes has a high oxygen content of about 70-80%. Thus, when the off-gas is recycled with air for the supplement of oxygen consumption, the gas mixture with an oxygen content of about 40% is used as feed gas for the PSA process, and CO2 generated by microbial breathing is also removed. Thus, the volume of a PSA column and an air compressor for supplying the feed gas can be reduced to less than ½ of the volume as compared to that of the use of air.

### TECHNICAL FIELD

The present invention relates to a method for enhancing the economic efficiency of a microbial process using pure oxygen produced at a low cost, and more particularly to a method for enhancing the economic efficiency of microbial processes using pure oxygen, in which pure oxygen with a purity of more than 85% is used in microbial processes using oxygen, such as fermentation and wastewater treatment processes, and off-gas from the microbial processes is recycled using a pressure swing adsorption (PSA) system so that the equipment cost and operating cost of the PSA system is significantly reduced.

### BACKGROUND ART

Air with oxygen content of 21% is utilized in a microbial fermentation process for producing various useful substances and an active sludge process for removing organic substances in wastewater. When pure oxygen with a purity of more than 85% is used, the utilization of high-concentration microorganisms in the microbial fermentation and active sludge processes becomes possible so that microbial productivity can be several times higher than that of the use of air, but the use of pure oxygen is limited to a laboratory setting due to its high cost. However, the following three methods are used to produce pure oxygen: (1) cryogenic fractionation using the difference in boiling point between oxygen and nitrogen; (2) pressure swing adsorption (PSA); and (3) oxygen separation using a membrane. Of such methods, the use of the PSA method is being spread and the production cost of pure oxygen is being decreased, and thus, it is expected that the use of pure oxygen will be increased.

Fermentation Process Using Pure Oxygen and High-Concentration Microorganisms

If cells, such as bacteria, yeasts, molds, plant cells and animal cells, are cultured in microbial processes at a far higher cell concentration than general cell concentration, the use of air with an oxygen content of 21% will cause oxygen deficiency so that the growth or desired metabolism of cells will be hindered. Examples of such microbial processes include a producing process of recombinant proteins using E. coli and yeasts, a producing process of antibiotics, such as penicillin, using molds, a process using immobilized microorganisms and cells, and an active sludge process in wastewater treatment (Lee, S. Y., TIBTECH, 14:96-105, 1996; Chang, H. N. & Furusaki, S., “Membrane Bioreactors: Presents and Prospects”, Advances in Biochemical Engineering and Biotechnology, 44:27-64, 1991, Springer-Verlag; Rittman B. E. & McCarty, P. L., “Environmental Biotechnology”, McGraw-Hill Korea, 2002).

Table 1 below shows the results of fermentation of polyhydroxybutyrate (PHB) which is a raw material of biodegradable plastic, conducted in the present inventor's laboratory. When comparing the PHB productivity between air and pure oxygen, it could be found that the pure oxygen showed 2.97 times higher PHB productivity at a 5 L reactor and 6.61 times higher PHB productivity at a 30 L reactor, as compared to air, and the larger the reactor volume was, the higher the effect of pure oxygen was (Shang, L. A. et al., Biotechnol. Bioeng, 83:312-20, 2003).

TABLE 1
Comparison of PHB prroductivity between air and oxygen in fed-batch
cultivation

| Fermentor | Supplying | Culture | Cell conc. | PHB conc. | |
|---|---|---|---|---|---|
| volume (L) | gas | time (h) | (g/L) | (g/L) | |
| 5 | O₂ | 45.0 | 208.2 | 138.7 | O₂-cylinder |
| 5 | air | 45.5 | 96.4 | 46.6 | |
| 30 | O₂ | 47.0 | 185.9 | 131.3 | O₂-PSA |
| 30 | air | 45.5 | 49.2 | 21.3 | |

Producing Processes of Pure Oxygen

Processes for industrially producing pure oxygen include a process of producing liquid oxygen by the fractional distillation of liquid air or the fractional liquefaction of air, in which the liquid oxygen has a purity of more than 99%, and power consumption is 1.51 Kwh/Nm³ (http://www.gastopia.co.kr). Also, a separation membrane with good permeability may be used to continuously produce oxygen from air, in which the produced oxygen has a purity of about 35˜55% and is used for medical applications. If the separation membrane is used in a two-stage manner, the purity of oxygen can be increased up to 90% (http://www.nitrogen.com). Recently, processes in which air is passed through a zeolite column with high nitrogen adsorption property to remove nitrogen and to recover oxygen at high concentration are frequently used. Such process is called “pressure swing adsorption (PSA)”, since adsorption and desorption are repeated using two or several columns to produce oxygen. In PSA process pressurized air was used as a raw material. Such PSA process includes two methods: one in which the purging of an adsorption column is performed by oxygen made in ambient pressure; and the other in which the purging of an adsorption column is achieved by a vacuum (http://www.cirmac.com). The former process shows a power consumption of 0.8˜1.4 Kwh/Nm³ and the latter process shows a power consumption of 0.43˜0.6 Kwh//Nm³ that is lower than the former process. The purity of oxygen produced by such processes is 90˜95% that is indicated as 93%. All the three processes as described above have been commercialized, and in producing low-purity oxygen, the process using the membrane is the most inexpensive, and the fractional liquefaction process is advantageous in applications requiring oxygen with a high purity of more than 99%. However, in applications requiring oxygen with a purity of about 90%, such as microbial fermentation and wastewater treatment, the PSA process can be expected to be the most suitable.

Problems of Prior Processes for Producing Pure Oxygen

For a fermentation process, it is reported that the supply of pure oxygen to a small-scale (about 2 L) fermentor from a tank containing 99% oxygen provides good results, but in a pilot-scale fermentor, the pure oxygen is not yet frequently used due to the problems of supply and cost. The largest fermentor in the fermentation process is about 300 m³, and when this fermentor is operated in 1 vvm (vol/vol·min), oxygen must be able to be supplied at 300 m³/min (18,000 m³/hour or 432,000 m³/day).

For wastewater treatment, an active sludge system using pure oxygen has a long history since initial use in 1970, but it is not frequently used due to the high cost of pure oxygen. However, as the production cost of oxygen is decreased with a recent development in the PSA process, the active sludge system is being applied up to wastewater treatment with the oxygen production of about 100 m³/hour (Metcalf & Eddy, “Wastewater Engineering”, 4^{th} ed., McGraw-Hill, 2003; http://www.oxair.com.au). It is reported that a process of purging a nitrogen adsorption column by a vacuum produces the largest amount of oxygen which can reach 5,000 m³/h (http://www.cirmac.com). The amount of air supply to a wastewater treatment tank is 20˜40 vvd (vol/vol·day)/m³, and thus, the total amount of air required in the standard active sludge tank with a scale of 5,000 m³ is 100,000˜200,000 m³/day. The use of pure oxygen allows the total air amount to be reduced to 20,000˜40,000 m³/day which is ⅕ of the total volume, and the capability of pure oxygen supply of the PSA system is 120,000 m³/day such that the PSA system can be applied to wastewater treatment.

Table 2 below shows the comparison of the power required to transfer 1 kg of oxygen from gas into solution in microbial processes. When oxygen in the air is used, air has no raw material cost but its oxygen content is 21%, and the pure oxygen produced by PSA has a purity of 93%. When 1 m³ of gas is aerated into liquid, the same power is consumed and thus the PSA oxygen is transferred 4.4 times (i.e., 93%/21%), as larger amount as oxygen in the air. As it can be seen in Table 2, the ratio of the total power consumption required to transfer 1 kg of oxygen of the PSA process to that of the air using process is 0.974 (i.e., 0.455/0.467) for low power and 0.505 (i.e., 1.264/2.500) for high power, in a fermentation process (F), and 1.057 (i.e., 0.445/0.421) for low power and 0.652 (i.e., 0.534/0.819) for high power, in a wastewater treatment process (W).

TABLE 2
Comparison of power consumption per kg oxygen between air using
process and PSA process

| | Air using | | |
|---|---|---|---|
| Contents | process | PSA process | |
| Oxygen content (%) | 21 | 93 | |
| Amount of oxygen | 0.299 | 1.428 | 44.6 gmol/mm³ |
| (kg/m³) | | | |
| ^{(a)}Consum- | 0.467˜2.5 | ^{(b)}0.105˜0.914 | |
| ing power F | | | |
| (Kwh/KgO₂) | | | |
| ^{(c)}Consum- | 0.421˜0.819 | ^{(b)}0.095˜0.184 | |
| ing power W (Kwh/ | | | |
| kgO₂) | | | |
| Producing power | | | |
| (Kwh/kgO₂) | | | |
| Producing power | — | ^{(d)}0.35 (0.5/1.428) | |
| (Kwh/kgO₂) | | | |
| ^{(e)}Total | 0.467˜2.5 | 0.455˜1.264 | |
| power consumption | | | |
| F (Kwh/kgO₂) | | | |
| ^{(e)}Total | 0.421˜0.819 | 0.445˜0.534 | |
| power consumption | | | |
| W (Kwh/kgO₂) | | | |

^{(a)}: (0.3˜1.5) kgO₂/kWh (Atkinson, B. & Mavituna, F., “Biochemical Engineering and Biotechnology Handbook, The Nature Press, pp 760-765, 1983).
^{(b)}: PSA = air × (0.21/0.93)
^{(c)}: (1.22˜2.39) kgO₂/Kwh (Reynolds, T.D. & Richards, P.A., Unit Operations and Process Environmental Engineering, International Thomson Publishing Asia, 1996).
^{(d)}: http://www.cirmac.com
^{(e)}: Total power consumption = consuming power + producing power

As being evident from the above examples, oxygen produced from air by the PSA process can be applied to fermentor or wastewater treatment equipment not only in laboratories, but also in pilot facilities and even industrial processes.

Although oxygen consumption can be reduced by a process of recycling off-gas with high oxygen concentration, the use of high concentration oxygen generates far larger amount of CO₂ than the use of the air does. According to studies conducted by the present inventors, it could be observed that the volume of CO₂ up to 10˜30% of the volume of the off-gas and significantly inhibited the PHB production from R. eutropha strains (Shang, L. A. et al., Biotechnol. Bioeng., 83:312-20, 2003).

In industrial processes requiring oxygen, such as fermentation or wastewater treatment processes, it is general to use air which has an oxygen content of only 21% but can be infinitely supplied. However, in a laboratory-scale study, the use of pure oxygen with a higher oxygen content than that of air has an advantage that the high-concentration culture of microorganisms is possible, and thus, annual amount of production is possible even by small facilities, so that the effects of an increase in productivity and reductions in equipment cost and energy can be achieved. Accordingly, if the supply cost of pure oxygen is lower than the advantage obtained by using the pure oxygen, the pure oxygen can have utility, and the economic efficiency of the pure oxygen can be increased in order of laboratory facilities, pilot facilities and industrial facilities. Thus, to increase the economic efficiency in large-scale industrial facilities, it is thought that minimizing the supply cost of oxygen is important, and adopting the PSA process with low energy consumption and high oxygen concentration is reasonable.

Meanwhile, in microbial industrial processes requiring oxygen, the availability of oxygen is mostly lower than 20% since the residence time of oxygen in solution is short even if pure oxygen is supplied. Namely, even if a gas mixture with oxygen content of more than 90% is supplied, about 15% of oxygen is consumed and the remaining 75% of oxygen is discharged as it is. Thus, if the discharged oxygen is used as feed gas for the PSA process and CO₂ contained in the off-gas is removed through the PSA process to produce pure oxygen, the volume of PSA columns can be reduced. In a process of introducing pure oxygen to wastewater treatment system, several chambers are formed in order to increase the utilization of pure oxygen and completely closed to prevent odors from being emitted to the outside (Schroeder, E. D., “Water and wastewater treatment”, McGraw-Hill, 1977).

Accordingly, having notice that the current PSA process produces oxygen with a purity of about 93% from air with an oxygen content of 21% as a raw material and considering that the availability of oxygen in microbial fermentation or wastewater treatment processes is about 20%, namely the oxygen content of off-gas from microbial processes is 70˜80%, the present inventors have found that, when the off-gas is recycled to remove CO₂ gas and only an oxygen portion consumed in microbial processes is supplemented with air or high-concentration oxygen produced by a membrane process, the efficiency of the microbial processes can be significantly enhanced. On the basis of this discovery, the present invention was perfected.

### DISCLOSURE OF INVENTION

In the present invention, (1) it was recognized that the utilization of pure oxygen with a higher oxygen content than that of air in microbial processes, such as fermentation and wastewater treatment processes, shows several times higher productivity than that of the existing processes using air with an oxygen content of 21%, (2) it was aimed to secure the process continuity and the economic efficiency of production cost in various oxygen production processes, (3) it was considered that the availability of oxygen in fermentation and wastewater treatment processes into which pure oxygen is fed is not so high (about 20˜30%), (4) the production cost of pure oxygen was minimized by using a single or complex oxygen production process, and removing CO₂ and water contained in the off-gas from microbial processes to produce high-concentration oxygen, and recycling the high-concentration oxygen, and therefore (5) the object of the present invention was to enhance the economic efficiency of microbial processes which had no economic efficiency due to the high cost of pure oxygen.

Regarding the above part (2), if mixed gas with an oxygen content of about 40% is obtained from air as a raw material by a PSA process or membrane process and then used as feed gas for the PSA process, the volume of an adsorption column used in the PSA process can be reduced to about ½ or less. Regarding the above part (3), if the off-gas from microbial processes is recycled to produce pure oxygen, the volume of an adsorption column in the PSA process can be reduced to ½ or less. The amount of consumed oxygen can vary depending on the amount of air and mixed gas (membrane process). Since the off-gas contains as much CO₂ as the amount of pure oxygen consumed, if flow rate is reduced and residence time is lengthened in order to increase the utilization of oxygen, the concentration of CO₂ in solution will be increased to inhibit the activity of microorganisms (Shang, L. A. et al., Biotechnol. Bioeng., 83:312-20; 2003).

Therefore, the main object of the present invention was to increase the oxygen concentration of feed gas to the possible maximum in order to minimize the volume of an adsorption column in PSA processes, which has great effect on the equipments, facilities and cost of production of oxygen. Namely, the object of the present invention is to minimize the volume of an adsorption column in a PSA process by recycling off-gas from fermentation and wastewater treatment processes using pure oxygen and to enhance the economic efficiency of the microbial processes using pure oxygen by adding air or gas having a higher oxygen content than that of air in order to supplement oxygen consumed in the microbial processes.

To achieve the above object, the present invention provides a method for producing useful substances by culturing microorganisms requiring oxygen, the method comprises the steps of: (a) introducing pure oxygen to a microbial culture process; (b) recycling the off-gas of the microbial culture process by PSA system to remove carbon dioxide and to recover pure oxygen; (c) introducing the recovered pure oxygen to the microbial culture process; and (d) repeating the steps (b) and (c).

Furthermore, the present invention provides a method for treating wastewater with microorganisms requiring oxygen, the method comprises the steps of: (a) introducing pure oxygen to a wastewater treatment process; (b) recycling the off-gas of the wastewater treatment process by PSA system to remove carbon dioxide and to recover pure oxygen; (c) introducing the recovered pure oxygen to the wastewater treatment process; and (d) repeating the steps (b) and (c).

In the present invention, in order to supplement oxygen consumed in the microbial process, separate air or high-concentration oxygen is preferably fed to the PSA system upon the recycling of the off-gas. As used herein, the term “pure oxygen” means oxygen with a purity of 100% and also mixed gas with a high oxygen content of more than 85%.

(1) The present invention is applied to the current fermentation process of producing useful substances using oxygen in the air or to the current wastewater treatment process of removing organic substances using oxygen in the air. (2) Since the fermentation process frequently utilizes a batch process or a fed-batch process, the apparatus and system of the present invention are utilized in the range between 25% and 70% of the total fermentation time. Since the wastewater treatment process is mostly a continuous process, the apparatus and system of the present invention are utilized over the entire operation time. (3) During the operation time of the inventive system, the entire amount of the off-gas from which water and CO₂ were removed if necessary is mixed with air, gas from membrane separation with an oxygen content of 25˜55%, or pure oxygen, in a tank, as shown in FIG. 1, such that consumed oxygen can be supplemented. The mixed gas is fed to the PSA system. (4) Nitrogen and carbon dioxide gases fed to the PSA system are exhausted to the outside, gas containing oxygen with a purity of more than 90% is fed to a microbial reactor again. In the PSA column, most of N₂ is removed and CO₂ is completely removed. (5) The prior method of feeding air is utilized for feeding pure oxygen into the microbial reactor. (6) As a result, the productivity in a fermentation process is increased by about 5 times than that of the use of air, and in a wastewater treatment process, the same amount of organic substances can be removed even when an active sludge tank with ½˜⅕ smaller size than the size of the existing active sludge tank is used. Furthermore, the present invention has an advantage that the size of an adsorption column can be reduced to the size of ⅓˜½ or less as compared to the conventional PSA system producing pure oxygen using air as feed gas, and thus, the costs of equipments, facilities and operation of the PSA system can be reduced.

### BRIEF DESCRIPTION OF THE DRAWINGS

FIG. 1 shows a concept of producing pure oxygen by PSA using a gas mixture of off-gas from a microbial process and air as a raw material.

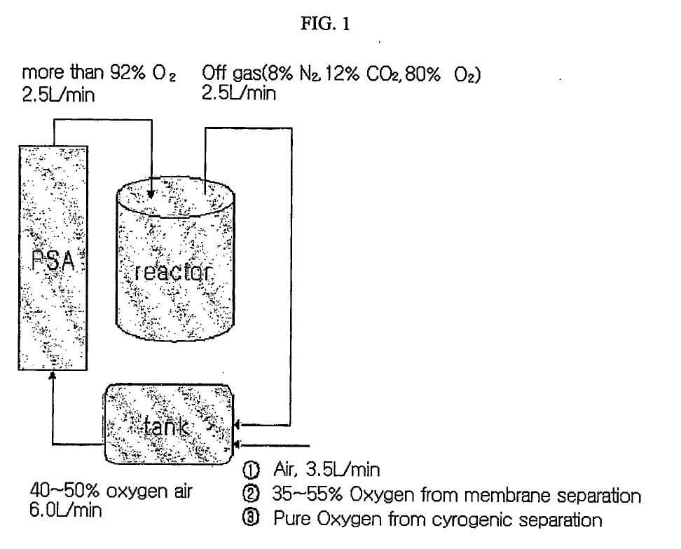

FIG. 2 shows a process of continuous operation of a PSA system.

FIG. 3 is a graphic diagram showing the production of pure oxygen by a PSA process using air as feed gas.

FIG. 4 is a graphic diagram showing the production of pure oxygen by a PSA process using an off-gas/air mixture with oxygen content of 40%.

FIG. 5 is a graphic diagram showing flow rate and pure oxygen concentration at the initial phase of an actual fermentation process where the inventive PSA process is continuously operated.

FIG. 6 is a graphic diagram showing flow rate and pure oxygen concentration at the exponential phase of an actual fermentation process where the inventive PSA process is continuously operated.

FIG. 7 is a graphic diagram showing the concentration of pure oxygen in the off-gas of a fermentation process which uses aerobic microorganisms.

### DETAILED DESCRIPTION OF THE INVENTION

The present invention will hereinafter be described in further detail by examples. It will however be obvious to a person skilled in the art that these examples are given for illustrative purpose only, and the scope of the present invention is not limited to or by these examples.

### EXAMPLE 1

### Continuous Process Operation of PSA System

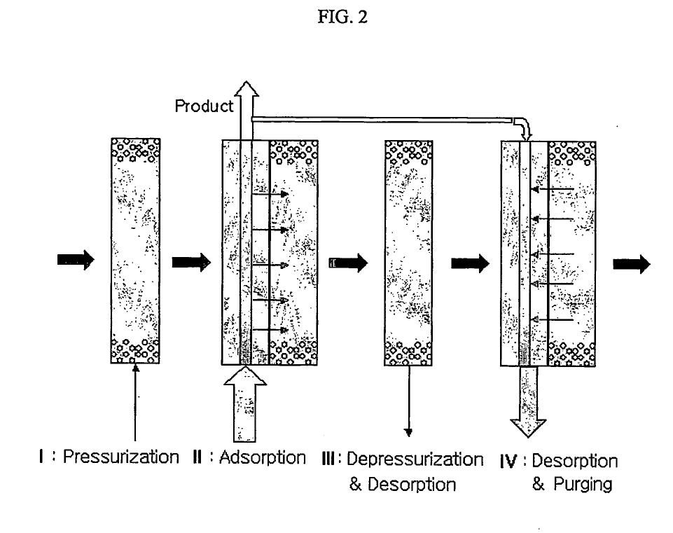

Although a PSA system can comprises two to several adsorption columns, FIG. 2 shows a PSA operation process of two adsorption columns (bed 1A and bed 1B). First, processes operating in one adsorption column are divided into a pressurization process (I), an adsorption process (II), a depressurization and desorption process (III), and a desorption and purging process (IV).

In step 1, the bed 1A is in the depressurization and desorption process, and the bed 1B is in the adsorption process. The step 1 has an operation time of 9 seconds and thus is a process requiring a relatively long time. In step 2, the beds 1A and 1B are subjected to pressure equilibrium for 2 seconds, and then in step 3, the bed 1A is subjected to the pressurization process (I) for one second, followed by the adsorption process (II) for 29 seconds in steps 4-6. In step 7, the bed 1A is subjected to equilibrium for 2 seconds, followed by the depressurization and desorption process (III) for 11 seconds in steps 8˜9, and then in step 10, subjected to the desorption and purging process (IV) for 10 seconds. And the bed 1A is returned to the depressurization and desorption process (III) in step 1 (see Table 3).

TABLE 3
Operation process of PSA columns

| Step | 1 | 2 | 3 | 4 | 5 | 6 | 7 | 8 | 9 | 10 |
|---|---|---|---|---|---|---|---|---|---|---|
| Bed 1A | III | eq | I | II | II | II | eq | III | III | IV |
| Bed 1B | II | eq | III | III | IV | III | eq | I | II | II |

| Pressure (bed 1A) | PL | PL-PH | | PH | | | PH-PL | PL | PM |
|---|---|---|---|---|---|---|---|---|---|
| Time (sec) | 9 | 2 | 1 | 10 | 10 | 9 | 2 | 10 | 10 |

eq: pressure equilibrium between two columns (bed 1A and bed 1B)
PL: low pressure, PH: high pressure, and PM: middle pressure

A section requiring the longest time is the pressurization (I) and adsorption (II) processes that account for 30 seconds of a cycle time of total 64 seconds. The next section is the depressurization and desorption (III) and the desorption and purging (IV) processes that require 30 seconds, and the remaining four seconds are the preparatory period between the adsorption process and the desorption process.

There are exactly five step differences in each cycle between the bed 1A and the bed 1B and they apart from each other by 2 seconds of the pressure equilibrium and 30 seconds. Regarding the pressure within the PSA columns, when taking the bed 1A as an example, the bed 1A is under low pressure (PL) in the depressurization process (III) of the step 1, and changed to high pressure (PH) in the steps 2˜3. The bed 1A is maintained at high pressure (PH) in the steps 4˜6, and then changed from high pressure to low pressure in the steps 7˜8. The bed 1A is under low pressure in the step 9, and has middle pressure in the desorption and purging process of the step 10.

### EXAMPLE 2

### Production of Pure Oxygen Using Air as Feed Gas

As the beds 1A and 1B, columns each having a diameter of 5 cm and a height of 57 cm were filled with alumina (D-201) and zeolite (CECA-CO₂ Li—X), and a vacuum pump (Hitachi, YEFO-KTPM) and an air compressor (KNF Neuberger, N811KN, 18) were used to construct a PSA system which can sufficiently realize the cycle time given in Table 3.

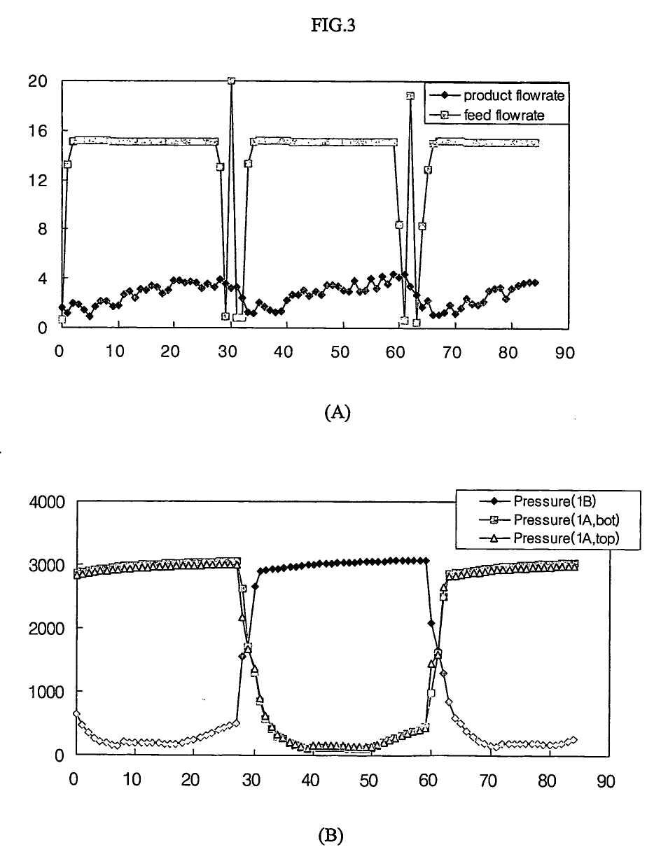

FIG. 3 shows feed flow rate (▪) and product flow rate (♦) when air was used as feed gas for a PSA column. In this case, a cycle time (sec) of 9-2-1-10-10-9-2-1-10-10 was used. When the feed flow rate of air was 15 L/min and adsorption pressure was elevated to 3,000 mmHg, O₂ with a purity of more than 92% could be obtained as much as 2.45 L/min (see FIG. 3). And, the recovery of oxygen from air was 71.5% [=(2.45×0.92)/(15×0.21)].

### EXAMPLE 3

### Production of Pure Oxygen by PSA Process Using Off-Gas/Air Mixture with Oxygen Concentration of 40%

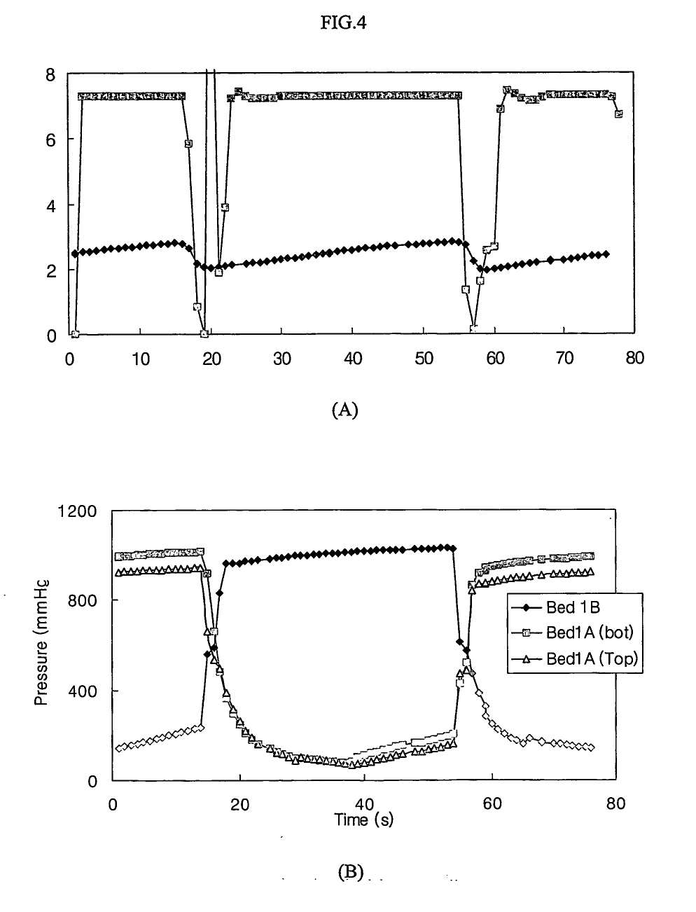

In this Example, the PSA system constructed in Example 2, a gas mixture (with O₂ content of 40%) which can be used in a fermentation process, and a cycle time (second) of 15-2-1-10-10-15-2-1-10-10 was used. Adsorption time was 36 sec, desorption time was 36 sec, and each equilibrium time was 2 sec. Flow rate and pressure are shown in FIG. 4. As shown in FIG. 4, when the flow rate of the mixed gas with an O₂ concentration of 40% was 6.7 L/min and adsorption pressure was elevated to 1,000 mmHg, O₂ with a purity of more than 92% could be produced as much as 2.44 L/min. And, the recovery of oxygen was 83.5% [=(2.44×0.92)/(6.7×0.4)].

Table 4 below shows the comparison of efficiency between the use of a gas mixture from recycled off-gas/air as feed gas to the PSA system and the use of air alone. When the mixed gas with an O₂ concentration of 40% was used as feed gas, the flow rate of the feed gas was low and the oxygen recovery was high. Particularly, in this case, the PSA system could be advantageously operated at a maximum adsorption pressure of 1,000 mmHg, whereas, when only air was used as feed gas, the PSA system could be operated at a maximum adsorption pressure of 3,000 mmHg.

TABLE 4
Comparison of efficiency between air and gas mixture of air/recycled off-
gas

| | Feed gas | | Off-gas | | | Maximum |
|---|---|---|---|---|---|---|
| | | Flow | O₂ | Flow | Recovery | adsorption |
| | conc. | rate | Conc. | rate | ratio | pressure |
| Contents | (%) | (L/min) | (%) | (L/min) | % | mmHg |
| 40.3% O₂ feed | 40.3 | 6.7 | 92.4 | 2.44 | 83.5 | 1000 |
| Air feed | 220.9 | 14 | 92.5 | 2.45 | 77.4 | 3000 |

### EXAMPLE 4

### Initial Operation of Microbial Fermentation Process with PSA System Using Recycled Off-Gas

The PSA system used in Example 3 was coupled to a 5 L fermentor using a wild type Ralstonia eutropha strain producing polyhydroxybutyrate (PHB), which is a biodegradable plastic, and the PSA column was fed with 7.3 L/min of air as a supplement to oxygen consumed in the fermentor. The operated PSA column was constructed as shown in FIG. 2, and had a cycle time (sec) of 15-2-1-10-10-15-2-1-10-10.

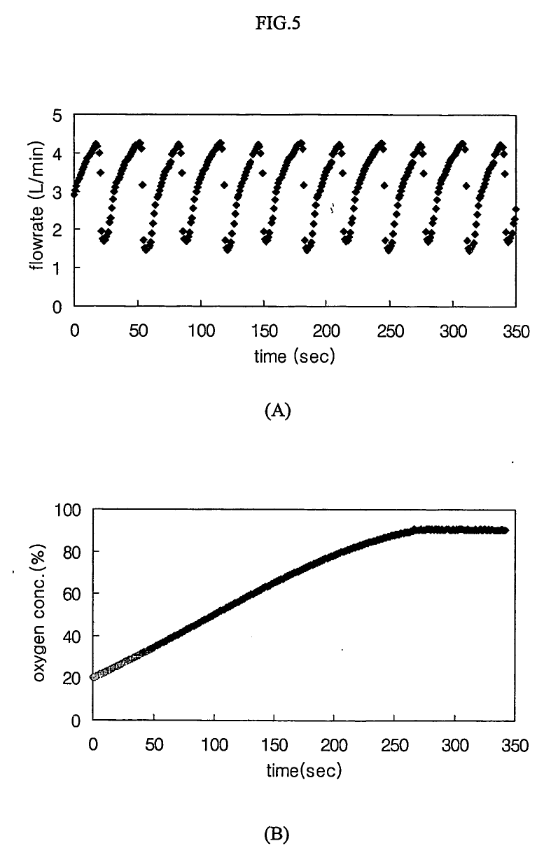

FIG. 5 shows the flow rate of pure oxygen (A) and a change in oxygen concentration (B) for about 6 minutes from fermentation start-up. As shown in FIG. 5A, the flow rate of pure oxygen had the highest average of about 3 L/min, and it was stably operated between the lowest flow rate of 1.5 L/min and the highest flow rate of 4.3 L/min. As shown in FIG. 5B, the oxygen concentration was increased from 21% to 90% within 5 minutes. It could be found that there was no oxygen consumed by cells at an initial fermentation stage so that the oxygen content of the off-gas was increased to 90%.

### EXAMPLE 5

### Long-Term Operation of Fermentation Process with PSA System Using Recycled Off-Gas

When a microbial process is operated in a fed-batch manner using the PSA system used in Example 3, biomass concentration per unit volume is low in an initial stage so that oxygen uptake rate per unit volume is not so high.
Total oxygen uptake rate (mg O₂/L·h)=[oxygen uptake rate per biomass weight (mg O₂/g·h)]×[biomass weight per unit volume (g/L)]

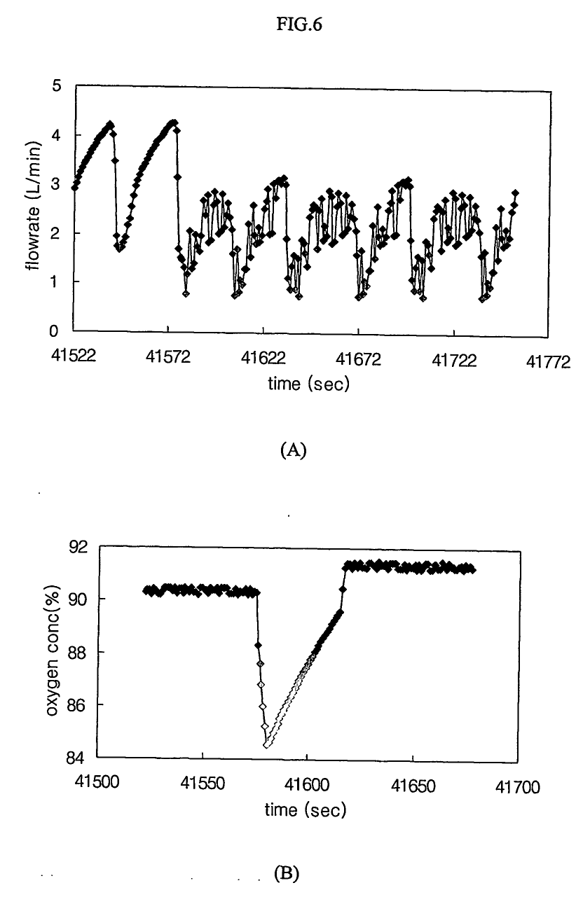

However, as the fermentation in Example 4 above is progressed, biomass concentration is increased to cause oxygen deficiency. In this case, pure oxygen is required. FIG. 6A shows a change in flow rate of off-gas when pure oxygen is fed after 41,572 seconds (11.5 hours). As shown in FIG. 6A, the oxygen uptake rate was increased to generate CO₂ in large amounts, and the content of CO₂ in off-gas was increased so that the flow rate of pure oxygen produced from the PSA system was reduced. As expected, CO₂ was 100% removed after passing through the PSA system. As shown in FIG. 6B, the content of oxygen in PSA off-gas was reduced from 90.2% to 84.5% and then increased again to 91.2% which is more than the initial content. This is because the oxygen uptake rate of biomass in the fermentation broth was reduced.

### EXAMPLE 6

### Use Method and Economic Efficiency in Industrial Facilities

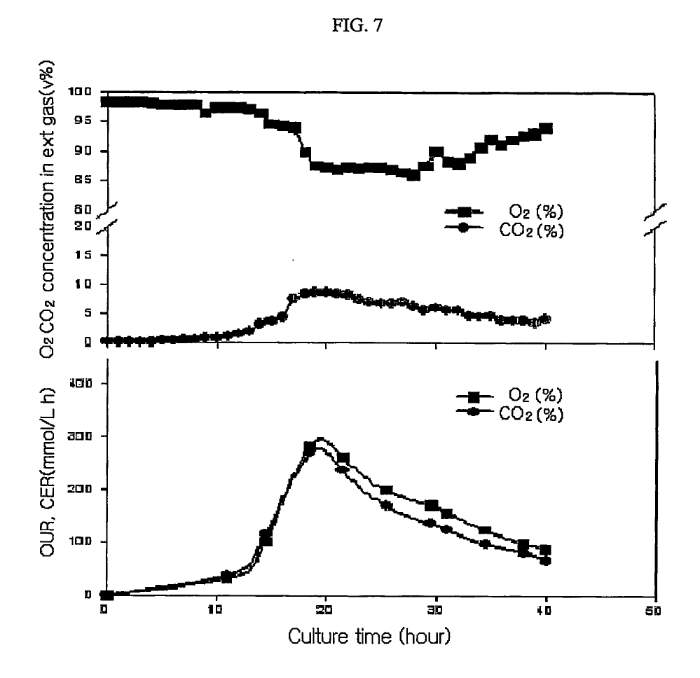

As shown in FIG. 7, the time required for pure oxygen to be consumed 15% is about 10 hours of a fermentation time of total 40 hours at a glucose concentration of 2.5 g/L, but increased to 28 hours of a fermentation time of total 45 hours at a glucose concentration of 40 g/L (Ryu, C. H., MS thesis, KAIST, 2003). Such times correspond to 25% and 62% of the total fermentation time, respectively. Thus, the size of the inventive PSA system can be minimized by the following method: (1) several fermentors are connected to one PSA system to increase the use time of the PSA system; or (2) oxygen is stored during the non-use period thereof, and if necessary, supplied as much as required.

Table 5 below shows the comparison of economic efficiency between the oxygen production by the inventive PSA process using recycled off-gas, the oxygen production from air according to the prior art and the oxygen production by the prior PSA process. The oxygen production from air does not require production power, but the PSA process requires production power and also equipment cost. However, the PSA process has 4˜5 times higher productivity than that of the use of air and thus can eliminate a need for a large area necessary for the installation of a reactor required in the use of air. The PSA process using recycled off-gas according to the present invention allows significant reductions in the size of the PSA system, the capacity of an air compressor, cost expenditure and power consumption.

Accordingly, the PSA process using recycled off-gas according to the present invention will act as a catalyst capable of improving other PSA processes and promoting the industrialization of the PSA processes. Recently, membrane cell recycle processes are significantly industrialized to remarkably increase oxygen uptake rate per unit volume as compared to the prior processes. This also serves as a momentum for enhancing the economic efficiency of the PSA processes.

TABLE 5
Comparison of power required for production of oxygen of 1 kg between
inventive PSA process using recycled off-gas, air using process, and the
prior PSA process

| | Process | | |
|---|---|---|---|
| | Air using | | |
| Comparison factor | process | PSA process | This invention |
| Oxygen contents (%) | 21 | 93 | 93 |
| Amount of oxygen | 0.299 | 1.428 | 1.428 |
| (kg/m³) | | | |
| ⁽¹⁾Consuming power F | 0.467˜2.5 | 0.105˜0.914 | 0.105˜0.914 |
| (Kwh/kgO₂) | | | |
| ⁽²⁾Consuming power | 0.421˜0.819 | 0.095˜0.184 | 0.095˜0.184 |
| W (Kwh/kgO₂) | | | |
| Producing power | — | 0.35 (=0.5/1.428 | ⁽¹⁾0.175 |
| Reactor size (%) | ⁽³⁾100 | 20˜25 | 20˜25 |
| PSA system size (%) | — | 100 | ⁽²⁾50 or less |
| Total power consump- | 0.467˜2.5 | 0.455˜1.264 | 0.280˜1.089 |
| tion F (Kwh/kgO₂) | | | |
| Total power consump- | 0.421˜0.819 | 0.445˜0.534 | 0.270˜0.359 |
| tion W (Kwh/kgO₂) | | | |

⁽¹⁾With respect to a 1:1 gas mixture of off-gas with an oxygen content of 60% and air with an oxygen content of 21%, the oxygen concentration of the gas mixture was assumed as about 40%. In fact, it is expected that the oxygen concentration of the gas mixture will be far higher than 40% so that the volume of an adsorption column for N₂ and CO₂ will be far smaller.
⁽²⁾According to the assumption of the above (1), the size of PSA system can be far smaller than 50% and the equipment cost of the system will be decreased to the system size to the power of 0.6.
⁽³⁾When air was used, the volume of a reactor was assumed as 100%.

### EXAMPLE 7

### Application to Wastewater Treatment Process

Although pure oxygen was first used in an active sludge tank in 1948, a commercial plant with the active sludge tank was built in 1969. The microbial concentration of the active sludge tank was 7,000˜10,000 mg/L, and currently, the active sludge tank is used in a small place and a place with a severe change in the amount of the load of organic substances (Schroeder, E. D., “Water and wastewater treatment”, McGraw-Hill, 1977). In this case, the concentration of gaseous oxygen is about 80%, and a PSA process and a fractional liquefaction process for producing oxygen using the difference in boiling point between oxygen and nitrogen are being proposed. Recently, bioreactors using a membrane is frequently installed and used, in which the microbial concentration reaches 15,000˜30,000 mg/L. Since the microbial concentration in this process is high, the use of pure oxygen in this process allows a further increase in productivity (Membrane Technologies for Industrial and Municipal Wastewater Treatment and Reuse, Water Environment Federation, 2000; http://www.wef.org). As a result, if pure oxygen is produced using the inventive PSA process using recycled off-gas, the efficiency and economic factor of a wastewater treatment process using microorganisms can be significantly enhanced.

While the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

### INDUSTRIAL APPLICABILITY

As described and proved above in detail, the use of pure oxygen in a fermentation process of producing useful substances and in a wastewater treatment process of removing organic substances allows the volume of a reactor to be reduced to ½˜⅕ of the volume as compared to the existing processes using air. When considering that the pure oxygen is not being used practically due to high production cost, the pure oxygen process according to the present invention has the following advantages.

First, since the volume of a fermentor in a fermentation process and an active sludge tank in a wastewater treatment process can be significantly reduced according to the present invention, the inventive process can be performed in a place with a far smaller area than that of the prior process. Second, the prior process for producing pure oxygen utilizes air with an oxygen content of 21% as a raw material, whereas the present invention utilizes a gas mixture with an oxygen content of more than 40%. Thus, the ratio of nitrogen to oxygen ratio is less than 1.5 in the present invention whereas it is 3.76 in the prior process, so that the present invention allows the volume of a PSA absorption column and an air compressor to be reduced to less than ½ of the volume as compared to the prior process. Third, in the prior microbial process using pure oxygen, the high content of CO₂ in fermentation broth has an effect on microbial metabolism, but in the present invention, CO₂ is removed in great amount in the PSA system so that the content of CO₂ in fermentation broth can be maintained at a low level.

As a result, the present invention has the effects of significantly reducing the equipment cost and operating cost of the pure oxygen production process to increase the economic efficiency of the process while taking the advantages of the microbial processes using pure oxygen. Also, the present invention has the effect of solving the CO₂ problem of the pure oxygen process.

The method according to the present invention can be applied to microbial fermentation processes in a laboratory, pilot or plant scale, and to active sludge processes in wastewater treatment plants, which could not been used due to the cost of a PSA oxygen generator and the noise of an air compressor for supplying a raw material. Thus, it is expected that the method of the present invention will contribute to the industrialization of processes which use pure oxygen.

What is claimed is:

1. A method for producing useful substances by culturing microorganisms requiring oxygen, the method comprises the steps of:
(a) introducing pure oxygen to a microbial culture process;
(b) recycling the off-gas of the microbial culture process to a pressure swing adsorption (PSA) system to remove carbon dioxide and to recover pure oxygen;
(c) introducing the recovered pure oxygen to the microbial culture process; and
(d) repeating the steps (b) and (c).

2. A method for treating wastewater with microorganisms requiring oxygen, the method comprises the steps of:
(a) introducing pure oxygen to a wastewater treatment process;
(b) recycling the off-gas of the wastewater treatment process to a pressure swing adsorption (PSA) system to remove carbon dioxide and to recover pure oxygen;
(c) introducing the recovered pure oxygen to the wastewater treatment process; and
(d) repeating the steps (b) and (c).

3. The method according to claim 1, wherein the separate air or high-concentration oxygen is fed to the PSA system upon the recycling of the off-gas.

4. The method according to claim 1, wherein oxygen content of the pure oxygen is 85˜100%.

5. The method according to claim 2, wherein the separate air or high-concentration oxygen is fed to the PSA system upon the recycling of the off-gas.

6. The method according to claim 2, wherein oxygen content of the pure oxygen is 85˜100%.
